(19) United States
(12) Patent Application Publication
(10) Pub. No.: US 2014/0281677 A1
(43) Pub. Date: Sep. 18, 2014

(54) ERROR CORRECTION METHOD AND DEVICE AND INFORMATION STORING DEVICE

(71) Applicant: KABUSHIKI KAISHA TOSHIBA, Tokyo (JP)

(72) Inventor: Hidetoshi KOIKE, Tokyo (JP)

(73) Assignee: KABUSHIKI KAISHA TOSHIBA, Tokyo (JP)

(21) Appl. No.: 13/960,665

(22) Filed: Aug. 6, 2013

(30) Foreign Application Priority Data
Mar. 18, 2013 (JP) 2013-055714

(51) Int. Cl. G06F 11/07

(52) U.S. Cl. CPC G06F 11/0727
USPC 714/6.1

(57) ABSTRACT

Error correction is carried out on first data stored in an external memory after determining that the first data contains a correctable error. Prior to starting the error correction of the first data, other accesses to the first data are blocked. Thereafter, the first data is corrected and overwritten by the corrected data (second data). After storing the second data in the external memory, accesses to the second data are permitted.

### CROSS-REFERENCE TO RELATED APPLICATION

This application is based upon and claims the benefit of priority from Japanese Patent Application No. 2013-055714, filed Mar. 18, 2013, the entire contents of which are incorporated herein by reference.

### FIELD

Embodiments relate to an error correction method and device, and an information storage device for correcting data error.

### BACKGROUND

In an information storage device such as hard disk drive (HDD) and solid state drive (SSD), an error of data read from a storage area is corrected. Generally, the data targeted for error correction, which is read from the storage, is stored for calculation in a temporary storage such as DRAM and SRAM. Error correction of the data stored in the temporary storage is sometimes controlled by CPU based on the drive firmware through a hardware unit which interfaces with the temporary storage. If the data stored in the temporary storage for error correction is shared among a plurality of other hardware or firmware (each referred to herein as a “block”), there is a risk of collision in the accesses to such data.

### DESCRIPTION OF THE DRAWINGS

FIG. 1 is a block diagram showing a configuration of an information storage device in which embodiments may be implemented.

FIG. 2 is a block diagram that shows components that execute error correction in the information storage device of FIG. 1.

FIG. 3 is a schematic diagram that shows error correction executed in the information storage device of FIG. 1 according to an embodiment.

FIG. 4 is a correction information table used in the error correction according to the embodiment.

FIG. 5 is a temporary save table used in the error correction according to the embodiment.

FIG. 6 is a flow chart describing an operational flow of the error correction executed in the information storage device of FIG. 1 according to the embodiment.

### DETAILED DESCRIPTION

In order to solve the problem of collision, embodiments provide an error correction method and device and an information storage device, which are capable of properly managing accesses from a plurality of blocks to data shared by these blocks.

According to an error correction method of one embodiment, before starting an error correction of first data stored in an external memory, other accesses to the first data are blocked. While other accesses are blocked, an error of the first data stored in the external memory is corrected, and second data resulting from the error correction of the first data is stored in the external memory. After storing the second data in the external memory, the other accesses that were blocked are now permitted and are directed to the second data.

Hereinafter, embodiments will be described using the drawings. The present disclosure is not restricted to the particular embodiments described here but can be realized with such embodiments modified without departing from the spirit of the present disclosure. Further, by a proper combination of several components disclosed in the following embodiments, various other embodiments can be implemented. For example, some components may be deleted and some components may be combined.

FIG. 1 is a block diagram showing the structure of an electronic system 150 including a magnetic disk device (hereinafter referred to as HDD) 10 as an information storage device in which embodiments may be implemented. The electronic system 150 includes a host 100 and the HDD 10. A host I/F 120 connects the host 100 and the HDD 10 for use in transferring commands and user data between the host 100 and the HDD 10. The HDD 10 is connected to the host 100 through the host I/F 120, and operates as a storage module of the host 100. In one example, the electronic system 150 is a personal computer or a mobile unit, and the host 100 is a chip set IC included in the personal computer and the like.

Although the embodiment will be described using the HDD 10 as an example of the information storage device, the embodiment can be applied to a device using a semiconductor memory as a recording medium (e.g., an SSD or a memory card) or an information storage device such as an optical disk drive and an optical magnetic disk drive. The information storage device according to embodiments corrects data error if the data read from the recording medium includes a correctable error.

The HDD 10 includes a magnetic disk 1, a slider 2, an arm 3, a VCM (voice coil motor) 4, and an SPM (spindle motor) 5. Further, the HDD 10 includes a circuit block of a motor driver 21, a head IC 22, an NVRAM (non-volatile RAM) 43, and a controller 60. The controller 60 includes a read and write channel unit (hereinafter, referred to as RDC) 31, a CPU 41, a RAM 42, and an HDC (Hard Disk Controller) 50. If there is some correctable error in the data recorded persistently in the magnetic disk 1 or the NVRAM 43, the HDD 10 according to the embodiment corrects the error in such data.

For example, the data read from the magnetic disk 1 in reply to a request from the host 100 is temporarily stored in a storage area (for example, the RAM 42) having a faster data transfer speed than that of the magnetic disk 1. Whether error correction on the temporarily stored data is needed or not is determined and the error correction is performed depending on the result. The temporarily stored data is accessed by a plurality of blocks (firmware or hardware) (also referred to herein as “memory access clients”). By properly arbitrating the accesses from plural memory access clients, the information storage device of the embodiment can properly manage the accesses from the plural blocks to the data which is stored in the storage area and shared among the plural blocks.

The magnetic disk 1 is fixed to the SPM 5 and rotated according to a rotation of the SPM 5. At least one surface of the magnetic disk 1 has a recording surface on which data can be magnetically recorded. That is, the magnetic disk 1 is a magnetic recording medium. On the recording surface, for example, a plurality of tracks having concentric circles are defined and each track includes a servo region and a data region. The servo region records the servo information including the positional information indicating a physical address on the recording surface of the magnetic disk 1. The data region records a program and management information for use in controlling the HDD 10 and the information transmitted from the host 100.

The slider 2 is arranged at one end of the arm 3 corresponding to the recording surface. The slider 2 includes a read head (not illustrated) and a write head (not illustrated). The read head magnetically reads a signal recorded on the recording surface of the magnetic disk 1. The read signal is supplied to the head IC 22 through a wire pattern on the arm 3. The write head magnetically records data on the recording surface of the magnetic disk 1 according to the write signal (write current) supplied through the wire pattern on the arm 3 from the head IC 22.

The arm 3 is provided with the slider 2 on its one end and a bearing 3a on its other end. According to the supply of the driving current to the VCM 4, the arm 3 rotates around the center of the bearing 3a and moves the slider 2 in a radial direction of the recording surface of the magnetic disk 1.

The VCM 4 is driven according to the driving signal (current) supplied from the motor driver 21 and rotates the arm 3.

The SPM 5 is driven according to the driving signal (current) supplied from the motor driver 21, to rotate the magnetic disk 1.

The motor driver 21 supplies the driving signal (current) for driving the VCM 4 to the VCM 4 and the driving signal (current) for driving the SPM 5 to the SPM 5, according to a control signal from the controller 60 (more specifically, the CPU 41).

The head IC 22 amplifies the signal supplied through the wire pattern on the arm 3 from the read head and supplies the amplified signal to the controller 60 (more specifically, the RDC 31) as read information. The head IC 22 supplies the write signal (write current) depending on the recording data supplied from the controller 60 (or the RDC 31) to the write head through the wire pattern on the arm 3.

The controller 60 may be formed as a SOC (System On Chip) including the RDC 31, the CPU 41, the RAM 42, and the HDC 50. In the embodiment, the controller 60 controls the error correction on the data read from the magnetic disk 1 or the NVRAM 43. In other embodiments, the controller 60 may be designed not to include the RAM 42 and instead to connect the RAM 42 that is located outside of the controller 60.

The RDC 31 extracts the servo information (including the address information and the positional information) corresponding to the servo region from the read data supplied from the head IC 22 and supplies the extracted servo information to the CPU 41. The RDC 31 extracts the data corresponding to the data region from the read information and performs the predetermined processing on the extracted data to decode the above information. The decoded data is supplied to the HDC 50. The RDC 31 performs the predetermined processing on the data to be recorded, which is supplied from the HDC 50, to encode the data and supplies the encoded data to the head IC 22 as data to be recorded. The RDC 31 uses the RAM 42 as a work memory for processing.

The CPU 41 is a processor which controls each block provided in the HDD 10 by executing firmware stored in the magnetic disk 1 or the NVRAM 43. For example, the CPU 41 controls the operations of the positioning of the read head on the recording surface of the magnetic disk 1, the rotation of the VCM 4 and the SPM 5, and the reproducing and recording of the information on the magnetic disk 1. The CPU 41 controls each block included in the HDD 10, according to a predetermined program, so that the controller 60 may operate as a servo controller or a read and write controller. The CPU 41 uses the RAM 42 as a work memory during such controls.

In the embodiment, if the controller 60 operates as the read and write controller, the CPU 41 controls the operation of the error correction performed in the data decoding in the HDC 50. The CPU 41 updates the correction management information for managing the state of the error correction and the state of the error occurrence, with respect to the data corrected by the error correction. Further, the CPU 41 manages the positional information of the storage area where the corrected data is stored, according to the error correction of the embodiment. An interrupt request by the firmware executed by the CPU 41 triggers the error correction. The information storage device according to the embodiment can properly manage the accesses from a plurality of blocks to the data shared among these blocks, according to this error correction.

The RAM 42 is a work memory of the RDC 31, the CPU 41, and the HDC 50. The RAM 42 temporarily stores the data targeted for the error correction executed mainly by the HDC 50. The RAM 42 stores the correction management information about the data corrected through the error correction. Further, the RAM 42 stores a program about the firmware executed by the CPU 41. DRAM (SDRAM) or SRAM, which is volatile memory, may used as the RAM 42. The data temporarily stored in the RAM 42 is accessed by the plural blocks of hardware or firmware. The primary memory access client to the information stored in the RAM 42 is the CPU 41.

The NVRAM 43 is a nonvolatile memory which stores a program executed by the CPU 41. The program stored in the NVRAM 43 can be updated. The NVRAM 43 stores values of parameters for use in the plural processes controlled by the CPU 41. The NVRAM 43 may store the correction management information about the data corrected by the error correction. The data stored in the NVRAM 43 may be targeted for the error correction executed by the HDC 40.

The HDC 50 communicates with the host 100 to transfer data therebetween. The HDC 50 encodes the data decoded by the RDC 31 through the predetermined processing and transmits the encoded data to the host 100 as transmission data. The HDC 50 decodes the data received from the host 100 through the predetermined processing and supplies the decoded data to the RDC 31 as the data to be recorded. For example, the HDC 50 executes communication with the host 100 in compliance with the SATA (Serial Advanced Technology Attachment) Standard. The HDC 50 also decodes or encodes the data of the firmware executed by the CPU 41. The HDC 50 temporarily records the data in the RAM 42 during the data encoding or decoding processing. In the embodiment, the HDC 50 corrects an error in the data if this data includes some correctable error.

According to the structure described above, error correction is performed on the correctable error through a plurality of blocks provided in the HDD 10 of the embodiment. Mainly, the HDC 50 performs this error correction on the data temporarily stored in the RAM 42. The data stored in the RAM 42 is accessed by plural blocks of hardware or firmware. The HDD 10 according to the embodiment can properly manage accesses from a plurality of blocks to the data shared among the blocks, because it properly arbitrates the accesses from the respective blocks.

Next, the structure of blocks that execute the error correction according to the embodiment, which is provided in the information storage device, will be described using FIG. 2. FIG. 2 is a block diagram that shows components that execute the error correction according to the embodiment.

The error correction according to the embodiment is executed by a plurality of blocks which are provided mainly in the HDC 50. These blocks are controlled by the firmware executed by the CPU 41.

The HDC 50 includes a memory controller 201, an arbitration unit 202, and a correcting unit 203. The CPU 41, the RDC 31, or the host 100 gains access to the data stored in the RAM 42 through the memory controller 201 and the arbitration unit 202. Namely, the CPU 41, the RDC 31, and the host 100 are memory access clients to the RAM 42.

Connected between the arbitration unit 202 and the RAM 42, the memory controller 201 is a hardware block for transferring data to and from the RAM 42. The memory controller 201 works as an interface for storing data into the RAM 42 and reading data therefrom. The memory controller 201 supplies a signal for recording data or reading data to the RAM 42, according to the address requested from the arbitration unit 202.

The arbitration unit 202 arbitrates the accesses from the CPU 41, the RDC 31, and the host 100 to the data stored in the RAM 42. The arbitration unit 202 also arbitrates the accesses from the plural firmware executed by the CPU 41 to the data stored in the RAM 42. In the error correction of the embodiment, the arbitration unit 202 preferentially maintains the access from the current memory access client to the data targeted for the error correction, which is stored in the RAM 42, and blocks the accesses from the other memory access clients. The memory access client in the error correction according to the embodiment is the CPU 41 (more specifically, the firmware for the error correction executed by the CPU 41).

The correcting unit 203 determines whether the data stored in the RAM 42 has a correctable error or not, and if so, it executes the error correction. During the error correction, the correcting unit 203 corrects the error while being controlled by the CPU 41 (more specifically, the firmware for the error correction executed by the CPU 41).

According to this structure, the error correction is executed such that it properly arbitrates the accesses from a plurality of memory access clients to the data stored in the RAM 42. Namely, the information storage device according to the embodiment can properly manage the accesses from a plurality of blocks to the data shared among the blocks.

Next, a schematic operation of the error correction executed by the information storage device according to the embodiment will be described using FIGS. 3, 4, and 5. FIG. 3 is a schematic diagram that shows the error correction according to the embodiment executed in the information storage device.

FIG. 3 schematically shows the data transfer between the RAM 42 and a memory access client 300 through the memory controller 201. During the data transfer shown in FIG. 3, the access from the memory access client 300 to the data stored in the RAM 42 is maintained. The access is maintained by a control of the arbitration unit 202.

The memory access client 300 reads the data stored in the RAM 42 at a specified address through the memory controller 201 in B301. The data reading from the RAM 42 through the memory access client 300 is also referred to as a burst transfer. Before B301, the arbitration unit 202 preferentially secures the access by the memory access client 300. In short, before B301, the arbitration unit 202 blocks accesses to the data stored in the RAM 42 at a specified address from a memory access client other than the memory access client 300.

In B302, the error correcting unit 203 determines whether there is a correctable error in the read data. If it is determined that there is no correctable error, the read data is provided to the memory access client 300; while, if it is determined that there is a correctable error, the error correcting unit 203 corrects the error and the corrected data is stored in the correction information table 310. In whichever case, the information about the error correction is stored in the correction information table 310. If the read data includes an uncorrectable error, the data read from a temporary save table 320 is provided to the memory access client 300. In the embodiment described herein, the correction information table 310 and the temporary save table 320 both hold the correction management information.

FIG. 4 shows one example of the correction information table 310 for use in the error correction according to the embodiment. Information of several flags represented by one bit is used in the correction information table 310 in order to indicate each correction state. The flag information includes “Stored Flag”, “Corrected Flag”, “Verified Flag”, and “Reassign Flag” but it is not restricted to these. The “Stored Flag” indicates whether or not there is correctable error in the data. The “Corrected Flag” indicates whether or not the error corrected data is written in the RAM 42. The “Verified Flag” indicates whether or not the data written in the RAM 42 is verified. The “Reassign Flag” indicates whether or not verified data is temporary saved based on the result of verification.

Each entry of the correction information table 310 includes the address information and the data and their error correction state defined with respect to the flag information. The address information indicates the address range of the data targeted for error correction check in the RAM 42. The data is the data targeted for error correction check or the error corrected data. Namely, according to the flag information, the error correction state of the data stored in the address range in the RAM 42 can be managed. For example, an error correction state having “0” in all the flag information indicates the state of having “no correctable error” in the data. In the example shown in FIG. 4, the address information “AD7” and data “DA7” refer to data that do not have any correctable error. Namely, the state having “0” in all the flag information can be used for adding new information. On the other hand, the data “DA0” in the address information “AD0” have “1” in all the flag information to indicate that there is an error as the result of verification check of the data stored in the RAM 42 after the error correction (“error exists after check”). In addition, the table 310 can indicate the following additional states: “correctable error exists” (indicating there is correctable error in the data), “correction finish” (indicating that the data with a correctable error has been corrected and stored in the RAM 42), and “no error after check” (indicating that there is no error as the result of verification check of the corrected data stored in the RAM 42).

Although the correction information table 310 is stored in a part of the RAM 42, it may be saved in a nonvolatile storage area (for example, the NVRAM 43 and the magnetic disk 1) before shutting down the power of the information storage device (RAM 42). Further, the information in the correction information table 310 does not have to be necessarily managed in a table format indicating a plurality of error correction states but the respective information may be managed using other formats.

Returning to FIG. 3, in B303 to B304, the memory access client 300 writes the error corrected data in the RAM 42 at the original address (the address where the data is read out) through the memory controller 201. Namely, the error corrected data is overwritten and updated at the original address.

In B305, the memory access client 300 reads the data overwritten in the RAM 42 (from the address where it is overwritten) again and the error correcting unit 203 verifies the read data.

In B306, if the error correcting unit 203 determines that the re-read data has an uncorrectable error, it stores the data in the temporary save table 320 together with the address information. In addition, regardless of the presence of an uncorrectable error in the re-read data, the information about the error correction is stored in the correction information table 310.

FIG. 5 shows one example of the temporary save table 320 for use in the error correction according to the embodiment. In the temporary save table 320, the data having “1” in all the flag information in the correction information table 310 corresponding to the state “error exists after check” is managed in correspondence with the address information. Namely, the data stored in the temporary save table 320 identifies the data possibly having an error.

Although the temporary save table 320 is stored in a part of the RAM 42, it may be saved in a nonvolatile storage area (for example, the NVRAM 43 or the magnetic disk 1) before shutting down the power of the information storage device (RAM 42). The information of the temporary save table 320 does not have to be managed necessarily in a table format but any format will do as far as the information is managed in a correspondence with the address information and the data. This address information and the data are also stored in the correction information table 310; therefore, only the address information can be stored in the temporary save table 320.

Returning to FIG. 3 again, in B307, the data stored in the temporary save table 320 can be replaced with the data read from the RAM 42 initially during the error correction in B301, hence to be provided to the memory access client 300. After finishing the process from B301 to B307, the arbitration unit 202 releases the access from the memory access client 300 to another memory access client. In short, after finishing the process from B301 to B307, the arbitration unit 202 permits the memory access clients other than the memory access client 300 to access the data.

According to the above operation, in the error correction of the embodiment, access to the data stored in the RAM 42 from a specified memory access client is protected by blocking accesses by other memory access clients. If the data stored in the RAM 42 has a correctable error, correction of this error can be executed without interruption by other memory access clients. Thus, according to the embodiment, accesses from a plurality of blocks to the data shared among the blocks can be properly managed.

Next, an operational flow of the error correction executed in the information storage device according to the embodiment will be described using FIG. 6.

Before the memory access client 300 starts an access to the RAM 42 for read data, the arbitration unit 202 starts the protection for this access (B600). When the memory access client 300 reads the data from the RAM 42 through the memory controller 201 (B601), under the protection of the access by the arbitration unit 202, the error correcting unit 203 checks the state of an error in the read data (whether or not there is an error) (B602). As the result of the error check (B603), if there is no error (No in B603), the error correcting unit 203 registers the check result in the correction information table 310 (B604). If there is an error as the result of the check (Yes in B603), the error correcting unit 203 determines whether the error is correctable or not (B605). If the error is correctable (Yes in B605), the error correcting unit 203 corrects the error and registers the information about the correction including the corrected data in the correction information table 310 (B604).

On the other hand, if the error is not correctable (No in B605), the memory access client 300 determines whether or not the address information where the data is read (and the data managed together) is stored in the temporary save table 320 (B606). If the address information (or data) is stored there (Yes in B606), the memory access client 300 reads the data stored in the temporary save table 320 and substitutes the above data for the data determined to be uncorrectable (B607). The process when the data is not stored in the temporary save table 320 (No in B606) will be described later.

After the information about the error correction is stored in the correction information table 310 (B605) and after the data is substituted for the data stored in the temporary save table 320 (B607), the memory access client 300 determines whether the error checked data is the final data of the data to be accessed (B608). If the data is not the final data (No in B608), the continuing access (namely, reading of the data from the RAM 42) (B601) is made again. If the error checked data is the final data (Yes in B608), the memory access client 300 confirms the information stored in the correction information table 310 (B609).

If new information has been registered in the correction information table 310 (Yes in B609), the memory access client 300 writes the target data stored as the new information in the RAM 42 at the corresponding address information and reads the data again. The error correcting unit 203 checks an error of the read data (verifies the read data) (B610). As the result of the error check (B611), if there is no error (No in B611), the error correcting unit 203 registers the check result in the correction information table 310 (B612). As the result of the check (B611), if there is an error (Yes in B611), the error correcting unit 203 tries to correct the error and registers the information about the correction, including the corrected data in the temporary save table 320 (B613). In addition, the error correcting unit 203 registers the check result in the correction information table 310 (B612). If there is plural new information in the correction information table 310, the above processing is performed on the respective information (data).

Upon completion of the access to the RAM 42 by the memory access client 300, when all the accessed data is transferred to the memory access client 300, the arbitration unit 202 releases this access (B614). If there is no new information in the correction information table 310 (No in B609) after the access to the final data, the access to the RAM 42 by the memory access client 300 is finished, all the accessed data is transferred, and the access is released in the same way. On the other hand, if the data read from the RAM 42 is not correctable and its address information (and data) is not stored in the temporary save table 320 (No in B606), the access to the RAM 42 by the memory access client 300 is interrupted and released (B615).

The firmware (memory access client 300) which executes the error correction of the embodiment sometimes accepts an interrupt request, for example, under the condition shown below, other than the respective processing in the flow chart shown in FIG. 6. The processing corresponding to the interrupt requests is respectively performed by firmware other than the firmware which executes the error correction. More specifically, as described later, the processing P1 is performed under the condition C1, and similarly the processing P2 to P5 is respectively performed under the conditions C2 to C5.

As the result of verification, if the correction information table is updated after detecting the correctable data, namely if the values of the respective flags in the correction information table 310 are updated to the state of (stored flag, corrected flag, verified flag, reassign flag)=(1, 1, 1, 0) (Condition C1), the updated information (flag information) with a correspondence of the address and the data in the correction information table 310 is cleared (Processing P1). In other words, clearing the flag information means that the values of the respective flags in the correction information table 310 are updated to the state of (stored flag, corrected flag, verified flag, reassign flag)=(0, 0, 0, 0).

As the result of verification, if the data read from the RAM 42 fails to recover (cannot correct an error) and the data is added to the temporary save table 320 as new information (Condition C2), the address of the newly stored data in the temporary save table 320 is confirmed because it fails to recover, the neighboring addresses of the above address in the RAM 42 are determined to be unusable, and the data of the neighboring addresses is stored newly in another address of the RAM 42 (Processing P2). After the completion of this processing, the information about the relevant address in the correction information table 310 and the temporary save table 320 is cleared.

If the correction information table 310 overflows (Condition C3), if there is no entry in the correction information table 310 having the state of (stored flag, corrected flag, verified flag, reassign flag)=(0, 0, 0, 0) (in other words, in the state possible to register no more new correction information) and new correctable data is detected, the contents of the information stored in the correction information table 310 are confirmed and the information unnecessary to be stored of the confirmed information is turned invalid, hence to secure a storage area for the information in the correction information table (Processing P3).

If uncorrectable data is detected regardless of the values of the flag information (state of error correction) in the correction information table 310 (Condition 4), different processing is performed depending on whether the data registered in the temporary save table 320 is used or not (Processing P4). When some information (address and data) was registered in the temporary save table 320, the above information should have been in the correctable state. If the data read from the address becomes uncorrectable, it can be determined that because the neighboring address of the above address in the RAM 42 may be physically damaged, its use should be stopped. Then, in this case, processing for moving the data registered in the temporary save table 320 to the other area (address area) of the RAM 42 is required. After this processing, the corresponding information (address and data) in the temporary save table 320 is cleared (to set the flag to be 0). On the other hand, if the corresponding information (address and data) is not registered in the temporary save table 320, whether the corresponding address data on the RAM 42 is damaged or not is checked again (for example, by writing and reading of the data at the corresponding address). If it is determined that the RAM 42 itself is not damaged, the data is loaded again (recovered) from the magnetic disk 1 or the NVRAM 43 where the corresponding data was originally stored.

If the temporary save table 320 overflows (Condition C5), the address of the data stored in the temporary save table 320 is confirmed, the neighboring addresses of the corresponding address of the RAM 42 are determined unusable, and the data is newly stored in the RAM 42 at the other address (Processing P5). After this processing, the information about the corresponding address in the temporary save table 320 is cleared.

According to this operational flow, the HDD 10 of the embodiment can correct an error while protecting the access from a specified memory access client to the data stored in the RAM 42. Namely, according to the error correction of the embodiment, if the data stored in the RAM 42 has a correctable error, the correction of this error can be executed while being protected from being accessed by other memory access clients. Thus, the information storage device of the embodiment can manage the accesses from a plurality of blocks to the data shared among these blocks properly.

As mentioned above, according to the embodiment, the information stored in the RAM 42 is accessed by the memory access client 300 through the memory controller 201. During the period of the error correction on the correctable data in this access, the arbitration unit 202 protects the above error correction by blocking the accesses from the other memory access clients.

Namely, according to the embodiment, since the time taken from the detection to the correction of an error is shortened in the error correction, if there exists such a bit failure that some bit characteristic in the RAM 42 is degraded, it is possible to restrain the bit failure, caused by a lot of time taken from the error detection to correction, from proceeding.

Further, according to the embodiment, since the priority is given to the control by the memory access client (firmware) for executing the error correction, there is no need to consider the interruption by the other memory access clients. Therefore, it is possible to simplify the structure of the firmware for executing the error correction. Further, it is also possible to avoid a collision of the access by the firmware for executing the error correction and the access by another memory access client (firmware). Furthermore, it is possible to continue the correction without interruption even if it takes much time to correct an error.

Further, since the error correction according to the embodiment is accompanied by the verification of the corrected data, it is possible to timely grasp the necessity of changing the stored position (address information) of the data stored in the RAM 42 and to set the stored position of the data stored in the RAM 42 suitably.

If the error correction according to the embodiment is applied to a device (for example, a device using a semiconductor storing medium such as SSD and a memory card) which requires much management information in recording data in the information storage area and frequently updates the management information, it can achieve much more effect.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An error correction method for correcting an error in data stored in an external memory, comprising:
reading first data having an error from the external memory;
preventing access to the first data stored in the external memory before starting an error correction of the first data;
after said preventing, correcting an error of the first data stored in the external memory to produce second data;
storing the second data in the external memory; and
permitting access to the second data after storing the second data in the external memory.

2. The method according to claim 1, wherein
said correcting an error of the first data includes managing and storing information indicating presence of a correctable error of the first data and information indicating whether the error correction of the first data has finished or not.

3. The method according to claim 1, wherein the access that is prevented and later permitted is requested by the same memory access client.

4. The method according to claim 1, wherein the access to the first data that is blocked and the access to the second data that is permitted are accesses to the same data object.

5. The method according to claim 1, wherein the first data is overwritten by the second data.

6. The method according to claim 5, further comprising:
reading the second data stored in the external memory;
verifying whether or not the second data read from the external memory has an error; and
if the second data read from the external memory has an error, storing the second data in a temporary save location, wherein the second data stored in the temporary save location is returned in reply to a read request for the second data.

7. The method according to claim 5, further comprising:
reading the second data stored in the external memory;
verifying whether or not the second data read from the external memory has an error; and
if the second data read from the external memory does not have an error, storing information indicating that the second data contains no error after check.

8. An error correction device comprising:
an interface for transferring data to and from an external memory;
a correcting unit configured to correct an error in data stored in the external memory; and
an arbitration unit configured to manage accesses to data stored in the external memory, such that during a time between the start of the error correction by the correcting unit and the end of the correction by the correcting unit, new accesses to the data stored in the external memory are blocked.

9. The device according to claim 8, wherein
the correcting unit is configured to manage and store information indicating presence of a correctable error of the data and information indicating whether the error correction of the data has finished or not.

10. The device according to claim 8, wherein the arbitration unit is configured to remove the block to the data stored in the external memory at the end of the error correction by the correcting unit.

11. The device according to claim 8, wherein the data stored in the external memory that is corrected is overwritten by the corrected data.

12. The device according to claim 11, wherein the correcting unit is further configured to read the corrected data from the external memory and verify whether or not the corrected data read from the external memory has an error.

13. The device according to claim 12, wherein
if the corrected data read from the external memory has an error, the corrected data is stored in a temporary save location.

14. The device according to claim 12, wherein
if the corrected data read from the external memory does not have an error, information indicating that the corrected data contains no error after check is stored.

15. An information storage device comprising:
a storage medium;
a first external memory for temporarily storing data read from the storage medium;
an error correction unit for correcting an error in data stored in the first external memory;
a second external memory for temporarily storing data read from the first external memory that has been corrected by the error correction unit; and
an arbitration unit configured to manage accesses to data stored in the first external memory, such that during a time between the start of the error correction by the error correction unit and the end of the correction by the error correction unit, new accesses to the data stored in the first external memory are blocked.

16. The device according to claim 15, wherein
the error correction unit is configured to manage and store in the second external memory information indicating presence of a correctable error of the data and information indicating whether the error correction of the data has finished or not.

17. The device according to claim 15, wherein the data stored in the first external memory that is corrected is overwritten by the corrected data.

18. The device according to claim 17, wherein the error correction unit is further configured to read the corrected data from the first external memory and verify whether or not the corrected data read from the first external memory has an error.

19. The device according to claim 18, wherein
if the corrected data read from the first external memory has an error, the corrected data is stored in the second external memory.

20. The device according to claim 18, wherein
if the corrected data read from the first external memory does not have an error, information indicating that the corrected data contains no error after check is stored in the second external memory.
